(19) United States
(12) Patent Application Publication
(10) Pub. No.: US 2019/0016015 A1
(43) Pub. Date: Jan. 17, 2019

(54) THERMOPLASTIC PREPREG PRODUCTION METHOD

(71) Applicant: KORDSA TEKNIK TEKSTIL ANONIM SIRKETI, Kocaeli (TR)

(72) Inventors: Deniz KORKMAZ, Kocaeli (TR); Egemen BILGE, Kocaeli (TR); Elcin CAKAL SARAC, Kocaeli (TR)

(73) Assignee: KORDSA TEKNIK TEKSTIL ANONIM SIRKETI, Kocaeli (TR)

(21) Appl. No.: 15/750,494

(22) PCT Filed: Aug. 3, 2016
(86) PCT No.: PCT/TR2016/050256

§ 371 Date: Feb. 5, 2018

(30) Foreign Application Priority Data
Aug. 3, 2015 (TR) 2015/09590

(51) Int. Cl. B29B 11/16; D03D 15/00; B29B 13/02

(52) U.S. Cl. CPC B29B 11/16; D03D 15/00; B29B 13/022; D03D 2700/0196; B29K 2309/08; D10B 2505/02; D10B 2101/12; D10B 2101/06; D10B 2331/021; D10B 2401/041

(57) ABSTRACT

The present invention relates to a thermoplastic prepreg production method which is developed in order to be used as structural and visual material in all industrial fields, mainly aviation, defense industry and automotive, and which enables the thermoplastic resin to be impregnated into the weave formed with a reinforcing yarn (A). The objective of the present invention is to provide a thermoplastic prepreg production method which enables to apply more accurate resin amount to the weavings comprising reinforcing yarn (A) and thermoplastic yarn (B), and to be processed more easily. Discloses is a thermoplastic prepreg production method characterized by the steps of i) obtaining a weave by weaving a thermoplastic yarn and a reinforcing yarn to each other, ii) impregnating of the said thermoplastic yarn into the said weave by melting or softening of said thermoplastic yarn.

### CROSS REFERENCE TO RELATED APPLICATIONS

This application is the national phase entry of International Application PCT/TR2016/050256, filed on Aug. 3, 2016 which is based upon and claims priority to Turkish Patent Application No. 2015/09590, filed on Aug. 3, 2015, the entire contents of which are incorporated herein by reference.

### TECHNICAL FIELD

The present invention relates to a thermoplastic prepreg production method which is developed in order to be used as structural and visual material in all industrial fields, mainly aviation, defense industry and automotive, and which enables the thermoplastic resin to be impregnated into the weave formed with a yarn that is manufactured from reinforcing fibers.

### BACKGROUND OF THE INVENTION

The prepregs are divided into two main categories, namely thermoset and thermoplastic. The thermoplastic prepreg is a structure comprised of thermoplastic resin impregnated yarns manufactured from reinforcing fibers. The thermoplastic prepregs are very popular today due to their lightweight, recycling potential, and resistance against corrosion properties.

Today, the resin used in thermoplastic prepreg production is applied as powder, film or granule. The thermoplastic prepregs that are obtained are then transformed into composite material which is the final product with production methods such as, thermoforming, compression molding via heat and pressure or overmolding.

In thermoplastic prepreg production, materials such as polyamides (PA) (polyamide 6 (PA6), polyamide 6,6 (PA66), polyphthalamide (PPA)), polyphenylene sulfide (PPS), polysulfone (PSU) polyarylenethersulfone, polyolefines (polyethylene (PE), polypropylene (PP) etc.), polyimide (PI), polyesters, preferably such as polyethylene terephthalate (PET) or polybutylene terephthalate (PBT), polyether ether ketone (PEEK) can be used.

Manual or automatic methods are preferred in feeding the resin in powder, film and granule form to the system. Especially powder and granule applications used in thermoplastic prepreg production cause homogenization problem in distributing resin, difficulty in using optimum raw material, and high amount of waste occurring during production.

Thermoplastic prepreg production is performed with discontinuous or continuous methods. In both discontinuous and continuous methods, even in case of feeding the resin in powder form is automatic, the thermoplastic resin/reinforcing fiber ratio cannot be applied in the desired accuracy. Variations occur in the powder amounts used in unit area. In case of it is supplied in granule form, since resin particles sizes are too big, accumulations occur since homogenous melting cannot be provided on the thermoplastic prepreg. The impregnation of the resin in the fiber structure is not easy due to same reason. In other words, the resin cannot penetrate into the structure comprises of yarn manufactured from reinforcing fibers homogenously.

U.S. Pat. No. 5,445,701, an application known in the state of the art, discloses a thermoplastic resin method in form of film. However, this method is expensive, as well as difficulties in supplying the film compatible for the desired thermoplastic material can be experienced.

In United States Patent Document no US20140030582, an application known in the state of the art, the wall thickness of the thermoplastic prepregs of the present invention can be produced in range of 0.3 and 6.0 mm. The said invention can function in a limited field since it is not for thermoplastic prepregs with bigger wall thickness.

U.S. Pat. No. 5,464,684, an application known in the state of the art, discloses a production method of the polyamide based hybrid yarn. In this method, thermoplastic yarn and reinforcing yarn are produced by mixing with each other by air application. Depending on the complexity of the yarn mixing process and application of twisting process on carbon fiber which is very brittle, causes decrease of the linear strength of the carbon fiber.

JP2006257573, JPS6395915, EP0426158 and U.S. Pat. No. 4,410,385 patent applications are also known from the prior art.

### SUMMARY OF THE INVENTION

The objective of the present invention is to provide a thermoplastic prepreg production method which enables the resin used in prepreg application to penetrate more into the weave relative to the conventional applications, in other words which enables the wettability of the weave.

Another objective of the present invention is to provide a thermoplastic prepreg production method which enables to apply more accurate amount of resin to the weaves comprising reinforcing yarn and thermoplastic yarn and also to provide more easily processing of them

### BRIEF DESCRIPTION OF THE DRAWINGS

The “Thermoplastic prepreg production method” fulfilled the objectives of the present invention is illustrated in the accompanying figures, in which:

FIG. 1 is the view of the weave type 2×2 twill which is subjected to the inventive thermoplastic prepreg application method; Plain thermoplastic prepreg.

FIG. 2 is the view of the weave type 2×2 twill which is subjected to the inventive thermoplastic prepreg application method; 2×2 twill thermoplastic prepreg.

FIG. 3 is the view of the weave type 4 harness satin which is subjected to the inventive thermoplastic prepreg application method; 4 harness satin thermoplastic prepreg.

FIG. 4 is the view of the weave type basket which is subjected to the inventive thermoplastic prepreg application method; Plain thermoplastic prepreg.

The components shown in the figures are each given reference numbers as follows:

A. Reinforcing yarn

B. Thermoplastic yarn

### DETAILED DESCRIPTION OF THE INVENTION

A thermoplastic prepreg production method comprises the steps of

i) obtaining a weave by weaving thermoplastic yarn with reinforcing yarn,

ii) impregnating the said thermoplastic yarn to the said weave by melting or softening.

The inventive thermoplastic prepreg production method, which enables the resin to penetrate into the weave homogenously and deeply in resin impregnation process realized in order to reinforce the formed weave, comprises the steps of
Weaving the determined thermoplastic yarn and reinforcing yarns for thermoplastic prepreg,
Increasing the temperature of the weave fabric above softening or melting point of the thermoplastic yarn,
Applying pressure (0-100 bar) on the weave fabric at this temperature,
Applying pre-tensioning (0-5 g/tex) on the weave fabric at this temperature,
Enabling the thermoplastic resin in yarn form to penetrate between the fibers of the reinforcing yarn inside the weave by melting,
Applying temperature and pressure for a time in range of 2-120 minutes,
Obtaining the ready to use final product by cooling until it reaches a temperature below glass transition temperature (T_{g}) of the resin without pressure or under pressure.

In the said invention, the thermoplastic yarns used in forming the weave is used in form of a thermoplastic yarn (B) selected from a group comprising polyamides (such as polyamide 6 (PA6), polyamide 6,6 (PA66), polyphthalamide (PPA)), polyphenylene sulfide (PPS), polysulfone (PSU) (such as polyethersulfone (PES), polyarylenethersulfone), polyarylenesulfide, fluoropolymer, polyacetal, polycarbonate, styrenic polymer, polyolefins (such as polyethylene (PE), polypropylene (PP)), polyimide (PI), polyetherimide, polyesters preferably polyethylene terephthalate (PET) or polybutylene terephthalate (PBT), polyether ether ketone (PEEK), polyether ketone (PEK), or combinations thereof.

In the said invention, as reinforcing yarn (A) used in forming the weave, a yarn produced from a material selected from the group comprising glass fiber, carbon fiber, aramid fiber, natural fiber, or a combination thereof is used.

The term “weave” used in the invention is defined as a system or pattern formed by intersection of weft and warp yarns. There are three basic two dimensional weaves: Plain, twill, and satin. All other weave types are derived from one or more of these types.

The term “weavings” used in the invention is the production method or process of interlacing two yarns from similar materials such that they cross each other at right angles to produce fabric. Warp yarns or ends extend along the fabric, and the weft yarns extend in horizontal direction. Weaving may be done in machine or handloom or by several hand methods.

The term “plain weave” used in the invention is one of the three main weave types, namely plain, satin, and twill. Each weft yarn passes successively over and under each warp yarn.

The term “satin weave” used in the invention is one of the three main weave types, namely plain, satin, and twill. The fabric surface is comprised almost completely of warp or weft produced in the repeat of the weave. The intersection points are distributed evenly and widely separated as possible. The characteristic property of the satin weave fabric is that it has a smooth and lustrous surface.

The term “twill weave” used in the invention is one of the main weave types, and it is characterized by diagonal lines produced by a series of floats staggered in the warp direction. A warp face twill is a weave in which the warp yarns produce the diagonal effect.

The term “dtex” used in the invention is the weight in grams per 10000 meter s yarn. The term “tex” used in the invention is the weight in grams per 1000 meters yarn.

In the inventive thermoplastic prepreg production method, the resin being in form of yarn manufactured from thermoplastic fiber enables the amount of resin/reinforcing fiber ratio in the thermoplastic prepreg to be adjusted easily.

In the present invention, the wall thickness of the thermoplastic prepregs which are the final products formed by penetrating the resin into the weaves is adjusted to be in range of 0.25 and 8 mm. The wall thickness of the single layer thermoplastic prepregs depends on the type of the used reinforcing yarn, areal weight of weave fabric and the pressure which is applied in the production. The wall thickness of the thermoplastic prepregs obtained by placing at least two layers of weave on top of each other depend on the number of layers, type of the used reinforcing yarn, areal weight of weave fabric and the pressure which is applied in the production.

The present invention comprises application of 0-100 bars, preferably in range of 1-40, of pressure on the resin in step of heating of the resin.

In the present invention, the cooling of the resin penetrating into the weave is carried out under 0-100 bars of pressure, preferably in range of 1-40 bars of pressure.

In the present invention, the weight of the thermoplastic resin is in range of 10% to 90%, preferably 30% to 70% of the weight of the yarn manufactured from reinforcing fibers.

In the preferred embodiment of the invention, the physical properties of the weave can be obtained similar or differently by using different kinds of yarns in weft and warp directions.

In a preferred embodiment of the invention, in order to provide unidirectional (UD) thermoplastic prepreg production, the thermoplastic yarns (B) are used as weft yarns in the weave.

The inventive thermoplastic prepregs can be used as structural and visual material in all industrial fields, mainly aviation, defense industry and automotive. The final product that is obtained is the semi-product called as the thermoplastic prepreg or organosheet.

In thermoplastic prepreg production, discontinuous or continuous methods can be used. The main principle used in both methods is to apply pressure (0-100 bars) at a temperature above softening or melting point of the thermoplastic resin, and to enable the resin to be impregnated into the reinforcing fibers in this way. Cooling process is applied after temperature and pressure is applied for a determined time between 2 minutes and 120 minutes. Cooling process can be applied without pressure or under pressure (0-100 bar) depending on the structure of the polymer. The cooling temperature is below the glass transition temperature (T_{g}) of the resin. The machine in which the inventive thermoplastics are produced can be heated up to 450° C. depending on the structure of the plastic. The temperature range that can be used in cooling process is between 25° C. and 200° C. The wall thickness of the inventive thermoplastic prepregs is in range of 0.25 mm to 8 mm. The applications known in the state of the art cannot provide the resin to be homogenously impregnated into the fibers. On the other hand, in the inventive method, since the resin is used in yarn form, the resin/reinforcing fiber ratio can be accurately adjusted. In summary, with the newly developed method, resin homogenization in amount is provided before starting the process. In order to provide the resin/reinforcing fiber ratio homogenously in a desired ratio in everywhere, the different dtex, different filament diameter and number of yarn produced from thermoplastic fibers can be used. With the thermoplastic yarn application, increasing in plastic surface area and regular material orientation enable the resin to be melt more easily relative to especially the powder and granule applications. Therefore, product with higher quality can be obtained in a machine which has lower accuracy. At the same time, the defects related to areal weight of resin are prevented.

The thermoplastics used in weaving application are applied in form of yarn which is warp and/or weft part of the weave. The yarns manufactured from reinforcing fibers (glass, carbon, aramid, natural fiber, etc.) are applied in warp and/or weft direction in similar way, and the obtained hybrid weaves are enabled to be appropriate for thermoplastic prepreg production. Two or more kinds of reinforcing yarns (A) can be used in hybrid weaves. For example, carbon, glass and thermoplastic yarn (B) can be used in the same weave.

Within the scope of the inventive method, raw material of the thermoplastic prepreg is obtained from the weave comprising reinforcing yarn (A) and thermoplastic yarn (B) from the weaving machine which is being currently used. Therefore, there is no extra process step required as conventional thermoplastic prepreg production during powder, film or granule coating application, and thus the production is carried out faster.

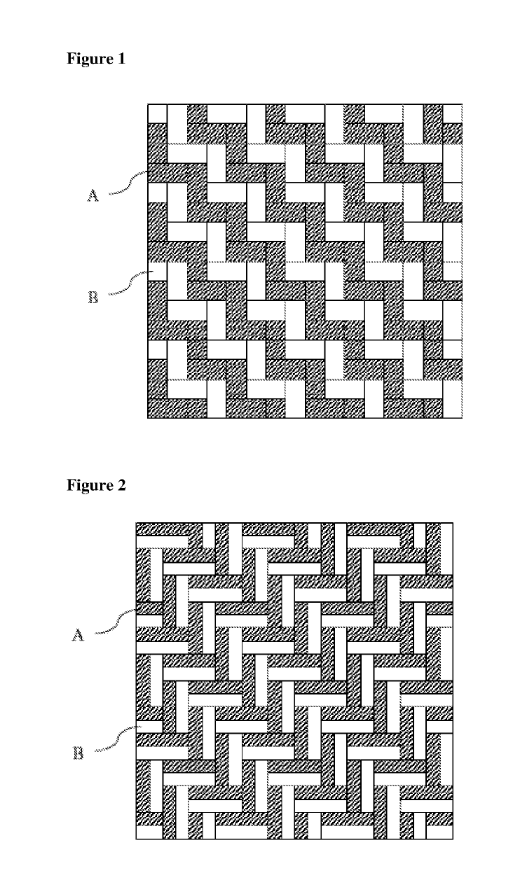

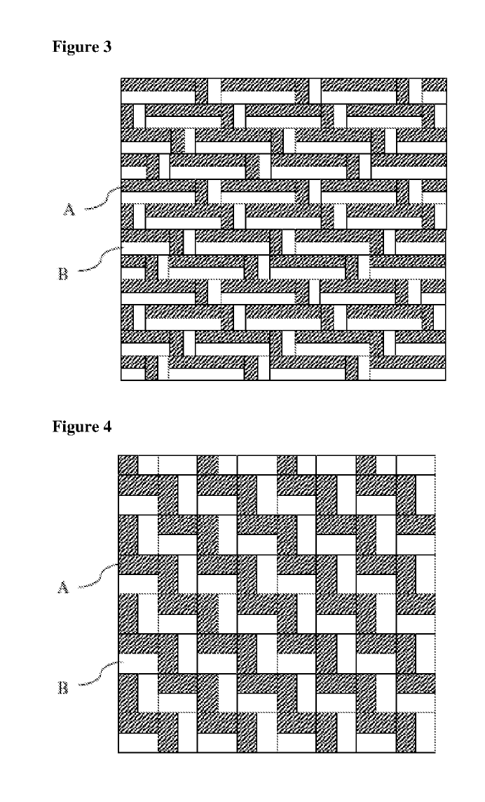

In production of thermoplastic prepregs, weaves comprising reinforcing yarn (A) and thermoplastic yarn (B) can be processed in more accurate resin amounts, and they can be processed more easily. The composite structure which is aimed to be the final product to be obtained can easily reach the required strength values with the selection of weaving type. As it can be seen from FIGS. 1, 2, 3 and 4, by means of the differently designed weave types, thermoplastic prepregs with different mechanical properties can be obtained. By this means the composite structure can be varied compatible with the field of use of the end user. The polymer based yarn to be used in the thermoplastic prepreg production can be applied in weft and/or warp direction. For example, by selecting 2×2 twill as weave type in FIG. 1, the produced thermoplastic prepreg comprises yarns manufactured from reinforcing fibers at 0 and 90 degrees in plain weave type.

What is claimed is:

1. A thermoplastic prepreg production method comprising:
obtaining a weave by weaving a thermoplastic yarn and a reinforcing yarn with each other wherein a weight ratio of the thermoplastic yarn to the reinforcing yarn is at least 10%;
impregnating the thermoplastic yarn into the weave by heating the thermoplastic yarn to a temperature above a melting or softening temperature of the thermoplastic yarn;
applying a pre-tensioning on the weave at the melting or softening temperature;
applying a pressure in a range of 0-100 bar on the weave during a melting or softening process of the thermoplastic yarn;
cooling a impregnated weave which is obtained at a temperature below a glass transition temperature (Tg);
applying the pressure in the range of 0-100 bar on the impregnated weave in step of cooling the thermoplastic yarn impregnated into the weave.

2. The thermoplastic prepreg production method according to claim 1, wherein the thermoplastic yarn is made of a thermoplastic material selected from the group consisting of polyamide, polyolefin, polyether ketone, polyether ether ketone, polyimide, polyetherimide, polyaryleneketone, polyarylene sulfone, polyarylene ether sulfone, polyarylene sulfide, fluoropolymer, polyacetal, polycarbonate, styrenic polymer, polyester or a combination thereof.

3. The thermoplastic prepreg production method according to claim 1, wherein the reinforcing yarn used in forming the weave is manufactured from a material selected from the group consisting of glass, carbon, aramid or natural fiber, or a combination thereof.

4. The thermoplastic prepreg production method according to claim 1, wherein a same kind of yarns are used in a weft direction and a warp direction of the weave.

5. The thermoplastic prepreg production method according to claim 1, wherein a uni-directional prepreg is obtained by using the thermoplastic yarn as a weft yarn in the weave.

6. The thermoplastic prepreg production method according to claim 2, wherein the thermoplastic material is enabled to impregnate into the weave in form of yarn.

7. The thermoplastic prepreg production method according to claim 1, wherein a plurality of different kinds of yarns are used in a weft direction and a warp direction of the weave.
